(19) United States
(12) Patent Application Publication
(10) Pub. No.: US 2012/0299288 A1
(43) Pub. Date: Nov. 29, 2012

(54) FUNCTIONALLY GRADED COMPOSITIONAL CONTROL METHODS TO ELIMINATE DISSIMILAR METAL WELDS (DMWs) DURING MANUFACTURE OF INTEGRAL HEADERS

(75) Inventors: David W. Gandy, China Grove, NC (US); John Shingledecker, Concord, NC (US)

(73) Assignee: ELECTRIC POWER RESEARCH INSTITUTE, INC., Charlotte, NC (US)

(21) Appl. No.: 13/463,587

(22) Filed: May 3, 2012

Related U.S. Application Data
(60) Provisional application No. 61/489,507, filed on May 24, 2011.

(51) Int. Cl. F16L 41/00; B22D 25/02; B22D 27/15; B22D 23/06; B22D 27/09

(52) U.S. Cl. 285/125.1; 164/80; 164/68.1; 164/61; 164/69.1

(57) ABSTRACT

A method of manufacturing a header assembly having a header section and a tube section includes the steps of providing a reverse mold of the header assembly, forming the header section by filling a header section of the reverse mold with an atomized low alloy steel powder, and forming the tube section. The tube section is formed by filling a first portion of a tube section with an atomized low alloy steel powder, forming a transition region by filling a second portion of the tube section with a series of atomized steel powders incrementally from a low alloy steel to an austenitic stainless steel, and filling a third portion of the tube section with an atomized austenitic stainless steel powder. The method further includes the step of consolidating and melting the atomized powders in a high temperature, high pressure atmosphere.

This application claims the benefit of Provisional Application No. 61/489,507 filed on May 24, 2011.

### BACKGROUND OF THE INVENTION

This application relates to a method of manufacturing header assemblies that are void of DMWs and eliminates the need for post-weld-heat-treatment.

Many fossil power plants were built for continuous base-load operation and are now beginning to see meaningful cyclic operation. Significant strains on components such as headers and high temperature piping are commonly associated with the cyclic practices often resulting in component degradation, cracking, and eventual failure of the component. Additionally, cyclic operation can result in thermal gradients at various locations along the length of headers which can lead to overheating and damage at these locations. When damage is encountered, utilities are often faced with the dilemma of replacing the entire header.

Conventional header design and fabrication requires fabrication of a long, thick pipe section wherein holes are bored to accept the header stub tubes. Carbon or low alloy steel and stainless steel headers are commonly fabricated using either rolled and welded (R&W) plate sections or extruded pipe sections. Penetrations (or holes) are machined into the header at specified orientations around the diameter and along specific lengths wherein stub tubes are then joined to the component. The stub tubes are joined via various welding methods and processes, depending on the manufacturer. This results in a header assembly that is commonly manufactured entirely (header and tubes) from a low alloy steel (ex., 2¼Cr-1Mo) or a creep strength enhanced ferritic steel (Grade 91).

A second weld is required to join the header/tube assembly in the field to austenitic stainless steel boiler tubes. In this application, dissimilar metal welds (DMWs) are employed between the SS boiler tubes and the low alloy or CSEF stub tubes. Normally a nickel-based filler metal is utilized to complete the tube-to-stub tube welds. Unfortunately, this is a difficult weld to perform in the field and with time at service temperature can result in failures due to carbon migration and reduced creep strength issues inherent to DMWs. One unique challenge to CSEF steels in this traditional approach is the need to perform a field post-weld heat-treatment (PWHT) on the stub tube. Because of the stub tube's proximity to the header, incorrect PWHT can cause damage to either the stub tube or the header itself.

### BRIEF SUMMARY OF THE INVENTION

These and other shortcomings of the prior art are addressed by the present invention, which provides a method of manufacturing header assemblies that are void of DMWs and eliminates the need for post-weld-heat-treatment.

According to one aspect of the invention, a method of manufacturing a header assembly having a header section and a tube section for use in connection of dissimilar metals between a boiler tube and the header assembly includes the steps of providing a reverse mold of the header assembly, forming the header section by filling a header section of the reverse mold with an atomized low alloy steel powder, and forming the tube section. The tube section is formed by filling a first portion of a tube section of the reverse mold with an atomized low alloy steel powder, forming a transition region by filling a second portion of the tube section of the reverse mold with a series of atomized steel powders incrementally from a low alloy steel to an austenitic stainless steel, and filling a third portion of the tube section of the reverse mold with an atomized austenitic stainless steel powder. The transition region is disposed between the first portion and the third portion such that the low alloy steel powder of the transition region is disposed next to the low alloy steel powder of the first portion and the austenitic stainless steel powder of the transition region is disposed next to the third portion. The method further includes the step of consolidating and melting the atomized powders in a high temperature, high pressure atmosphere to form the header assembly.

According to another aspect of the invention, a header assembly for use in connecting between low alloy steel piping and austenitic stainless steel tubes includes a header section formed of a low alloy steel and a tube section extending outwardly from the header section. The tube section includes a first low alloy steel section connected to the header section, a second transition section, and a third austenitic stainless steel section for connection to the austenitic stainless steel tubes, wherein the second transition section is disposed between the first low alloy steel section and the third austenitic stainless steel section.

### BRIEF DESCRIPTION OF THE DRAWINGS

The subject matter that is regarded as the invention may be best understood by reference to the following description taken in conjunction with the accompanying drawing figures in which:

FIG. 1 shows an integral header to tube attachment according to an embodiment of the invention; and

FIG. 2 is a flow diagram of the method for manufacturing a header assembly.

### DETAILED DESCRIPTION OF THE INVENTION

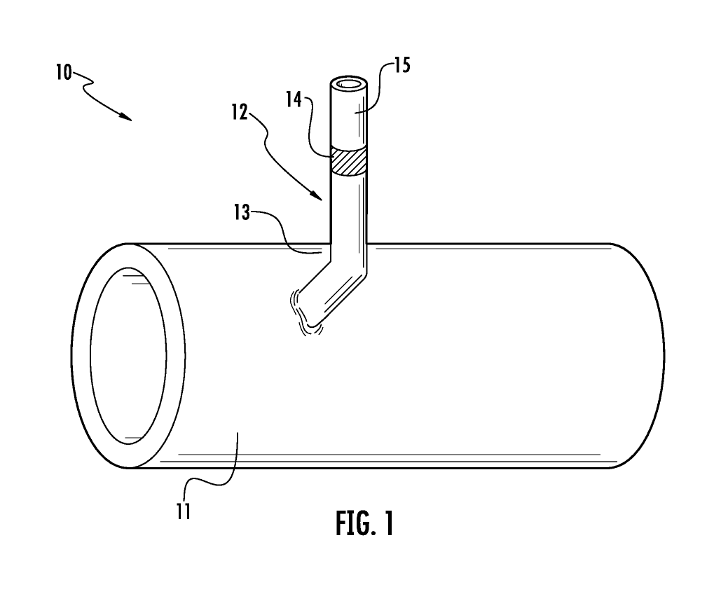

Referring to the drawings, a header assembly formed in accordance with an embodiment of the invention is illustrated in FIG. 1 and shown generally at reference numeral 10.

The current invention utilizes an entirely new manufacturing technology to completely eliminate the need for DMWs in header assemblies. The manufacturing method employs functionally graded compositional controls produced via powder metallurgy & hot isostatic processing (PM/HIP) to produce a smooth compositional transition from a stub tube alloy to a boiler tube alloy. In this approach the entire header assembly 10 is manufactured using PM/HIP including the stub tubes 12. The novelty of the approach however is that the final 1-2 inches of the tube 12 are produced with a functionally graded composition such that the composition gradually changes from a low alloy steel (or CSEF steel) section 13 to an austenitic stainless steel section 15 using a transition section 14 which is formed by a series of incrementally applied steel powders from an atomized low alloy steel powder to an atomized austenitic steel powder. This is accomplished through utilization of a PM compositional controls to gradually transition the alloy from the lower Cr (2¼Cr or 9Cr) to the 18Cr austenitic stainless steel boiler tube alloy. Use of the process eliminates the DMW that is normally required for joining the header tube assembly to the boiler tube. By producing the functionally graded integral header, all heat-treatment can be performed in a controlled shop environment thus eliminating the need for post-weld heat-treatment in the field.

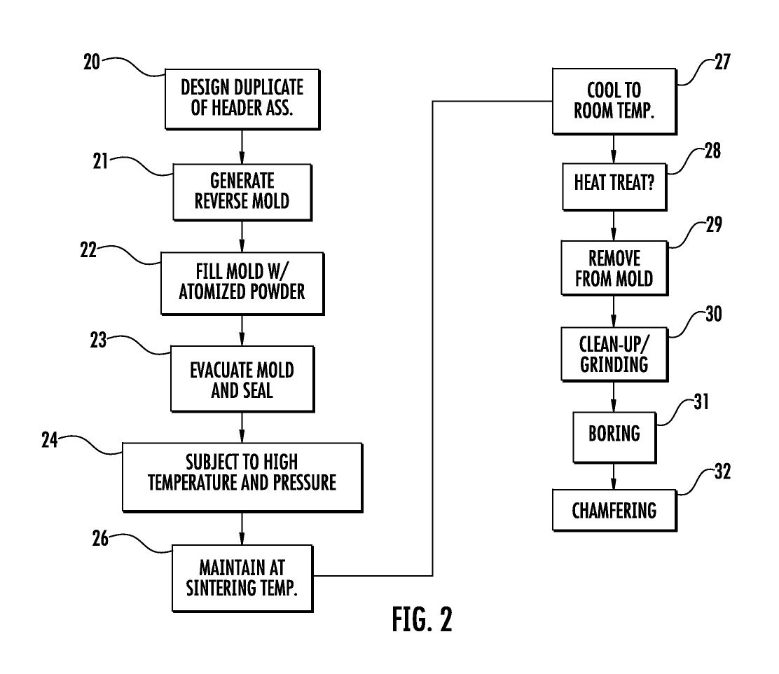

The HIP/PM technology eliminates the rolled & welded or extrusion manufacturing steps as a header section can be produced as one completed system. More importantly, it eliminates the joining of the stub tube 12 to the header 11 as the stub tube 12 and header 11 are integrally manufactured in one continuous PM/HIP process. Most importantly, the dissimilar metal weld (DMW) traditionally performed in the field is eliminated by grading the composition in the stub tube 12 from the low-Chromium alloy steel or CSEF steel to an 18 wt % Cr stainless steel which can be welded to the stainless superheater tubing after installation. Referring to FIG. 2, the process involves design of an exact duplicate of the a header section, Block 20, including the full tube sections, FIG. 1, beyond the typical DMW joint which can be obtained from drawings of the header. Next, a reverse mold (container) of the header section is generated, Block 21, in two halves (or more) from a carbon steel material that establishes the final shape of the header section. The mold is assembled together and then filled with an atomized low alloy steel powder to fill the mold, Block 22. Composition of the stub tubes is graded by filling with successive layers of decreasing chromium content alloy from an 18% wtCr stainless steel to the 9% or 2%% Cr ferritic steel, Block 22. Next, the mold is evacuated using a vacuum to eliminate any potential air pockets and then sealed via welding, Block 23.

The entire assembly is then inserted into a HIP furnace and brought to a high temperature and pressure (usually under an inert argon atmosphere) to consolidate and sinter the powder into the final shape of the header, Block 24. The assembly is maintained at the sintering temperature for a given period of time, Block 26, and then allowed to cool to room temperature, Block 27. Additional heat treatment will likely be required to bring the header to a normalized and tempered condition for service, Block 28. This final heat treatment can be performed in or out of the can. Removal of the can is required once the header has been allowed to return to room temperature, Block 29.

At this point, the header should be in a near-net shape (near final shape) condition. Some clean-up and grinding may be required to assure that the can, mold and any residuals are removed to obtain a final surface, Block 30. A couple of additional steps are also required at this point: (1) boring of the stub tubes to produce an inner penetration, Block 31, and (2) chamfering of the inside diameter of the bore regions, Block 32. Both of these operations are easily accomplished using CNC milling/boring operations.

It should be pointed out once again that the stub tubes are now an integral part of the header that requires no weld transition between the header and stub tube, a region of considerable problems in the past. Elimination of the weldment, removes thermal expansion concerns, potential fatigue and creep damage issues, and wedging that is often associated with the weld attachment of a stub tube. As an integral stub tube, only welds to attach the stub tube to the existing boiler tubes are required, significantly reducing future damage. Because the shape can be carefully controlled, repeatable smooth transitions between the stub and header are achieved reducing the potential for stress risers. Most importantly, the end of the stub tubes is the same stainless steel composition as the superheater it will be joined to in the field. By functionally grading the composition via the powder metallurgy method, the DMW joint is eliminated.

The foregoing has described a method for manufacturing header assemblies that are void of DMWs and eliminates the need for post-weld-heat-treatment. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. A method of manufacturing a header assembly having a header section and a tube section for use in connection of dissimilar metals between a boiler tube and the header assembly, comprising the steps of:
(a) providing a reverse mold of the header assembly;
(b) forming the header section by filling a header section of the reverse mold with an atomized low alloy steel powder;
(c) forming the tube section by:
(i) filling a first portion of a tube section of the reverse mold with an atomized low alloy steel powder;
(ii) forming a transition region by filling a second portion of the tube section of the reverse mold with a series of atomized steel powders incrementally from a low alloy steel to an austenitic stainless steel;
(iii) filling a third portion of the tube section of the reverse mold with an atomized austenitic stainless steel powder, wherein the transition region is disposed between the first portion and the third portion such that the low alloy steel powder of the transition region is disposed next to the low alloy steel powder of the first portion and the austenitic stainless steel powder of the transition region is disposed next to the third portion; and
(d) consolidating and melting the atomized powders in a high temperature, high pressure atmosphere to form the header assembly.

2. The method according to claim 1, wherein the step of consolidating and melting occurs in and inert gas atmosphere.

3. The method according to claim 1, further including the step of subjecting the mold to a vacuum to eliminate air pockets.

4. The method according to claim 3, further including the step of sealing the mold to maintain vacuum.

5. The method according to claim 1, further including the step of cooling the mold and consolidated powders to room temperature.

6. The method according to claim 1, further including the step of heat treating the header assembly.

7. The method according to claim 1, further including the step of finishing the header assembly into final form by:
(a) grinding an outer surface of the header assembly to remove any residuals;
(b) boring the tube section of the header assembly to produce an inner penetration; and
(c) chamfering an inside of the bored tube section.

8. The method according to claim 1, further including the step of inserting the mold and atomized powders into a hot isostatic processing furnace to consolidate and melt the atomized powders.

9. A header assembly for use in connecting between low alloy steel piping and austenitic stainless steel tubes, comprising:
(a) a header section formed of a low alloy steel; and
(b) a tube section extending outwardly from the header section having:
(i) a first low alloy steel section connected to the header section;
(ii) a second transition section; and
(iii) a third austenitic stainless steel section for connection to the austenitic stainless steel tubes, wherein the second transition section is disposed between the first low alloy steel section and the third austenitic stainless steel section.

10. The header assembly according to claim 9, wherein the tube section is integrally-formed with the header section.

11. The header assembly according to claim 9, wherein the second transition section is formed by a series of incrementally applied steels starting with a low alloy steel for mating with the first alloy steel section and progressively increasing in chromium content to an austenitic stainless steel for mating with the third austenitic stainless steel section.

12. The header assembly according to claim 9, wherein the first alloy steel section, second transition section, and third austenitic stainless steel section form a seamless tube section.
